(19) United States
(12) Patent Application Publication
(10) Pub. No.: US 2007/0157004 A1
(43) Pub. Date: Jul. 5, 2007

(54) MULTI PURPOSE SWITCHING CIRCUIT AND ELECTRONIC APPARATUS INCLUDING SAME

(75) Inventors: Han-Che Wang, Shenzhen (CN); Chun-Wei Pan, Shenzhen (CN); Shin-Hong Chung, Shenzhen (CN); Chen-Hsuan Ho, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/616,027

(22) Filed: Dec. 26, 2006

(30) Foreign Application Priority Data
Dec. 30, 2005 (CN) 200510121404.7

(51) Int. Cl. G06F 15/00

(52) U.S. Cl. 712/1

(57) ABSTRACT

A multi purpose switching circuit is provided. The multi purpose switching circuit is connected with a main unit (60) of an electronic apparatus and includes a multi purpose switch (10). The multi purpose switch is capable of receiving multiple manual operational inputs and accordingly producing multiple command signals. The multiple manual operational inputs are identified by a pushing time and a pushing count in a predetermined time of the multi purpose switch. The multiple command signals initiate the main unit to implement multiple functions such as starting up, shutting down and resetting itself. An electronic device including such a multi purpose switching circuit is also provided.

### TECHNICAL FIELD

The present invention relates to switching circuits and electronic apparatuses including same, and particularly to a multi purpose switching circuit and an electronic apparatus including same.

### RELATED ART

An intelligent electronic apparatus is always made up by hardware and software. The hardware and software co-operate with each other to implement multiple functions. Among the multiple functions, excluding the functions that are triggered within the intelligent electronic apparatus, other functions, such as powering on, powering off, and resetting the intelligent electronic apparatus are triggered by manual operational inputs via input devices such as mechanical switches.

With the development of electronics technology and the improvement in people's daily life, on one hand more and more functions have been equipped into the intelligent electronic apparatus, but on the other hand the intelligent electronic apparatuses, especially portable intelligent electronic apparatuses such as cell phones and MP3s are required to decrease volumes, in order to attract consumers. If each mechanical switch mounted on an intelligent electronic is still provided to triggered one or two functions and not to trigger three or more functions, the total mechanical switches required by the intelligent electronic apparatuses are still numerous and the intelligent electronic apparatus are hardly to meet the consumers' requirements of decreased volumes.

Therefore, there is a need for providing a multi purpose switching circuit and an electronic apparatus including same which can trigger multi functions with one mechanical switch.

### SUMMARY

A multi purpose switching circuit is provided in accordance with a preferred embodiment. The multi purpose switching circuit is connected with a main unit of an electronic apparatus which is capable of implementing multi functions. The multi purpose switching circuit includes a multi purpose switch that is capable of receiving multiple manual operational inputs and accordingly producing multiple command signals, the multiple manual operational inputs being identified from each other by either a pushing time or a pushing count in a predetermined time length of the multi purpose switch and used to initiate the multiple functions of the main unit.

An electronic device is also provided. The electronic device includes a main unit being capable of implementing multi functions; and a multi purpose switching circuit including a multi purpose switch connected with the main unit and being capable of receiving multiple manual operational inputs and accordingly producing multiple command signals. The multiple manual operational inputs are identified from each other by either a pushing time or a pushing count in a predetermined time of the multi purpose switch and used to initiate the multi functions of the main unit.

Other advantages and novel features will be drawn from the following detailed description with reference to the attached drawings, in which:

### BRIEF DESCRIPTION OF THE DRAWINGS

FIG. 1 depicts an exemplary block diagram of a multi purpose switching circuit in accordance with a preferred embodiment of the present invention; and

FIG. 2 depicts a circuit diagram of the multi purpose switching circuit of FIG. 1.

### DETAILED DESCRIPTION OF THE EMBODIMENTS

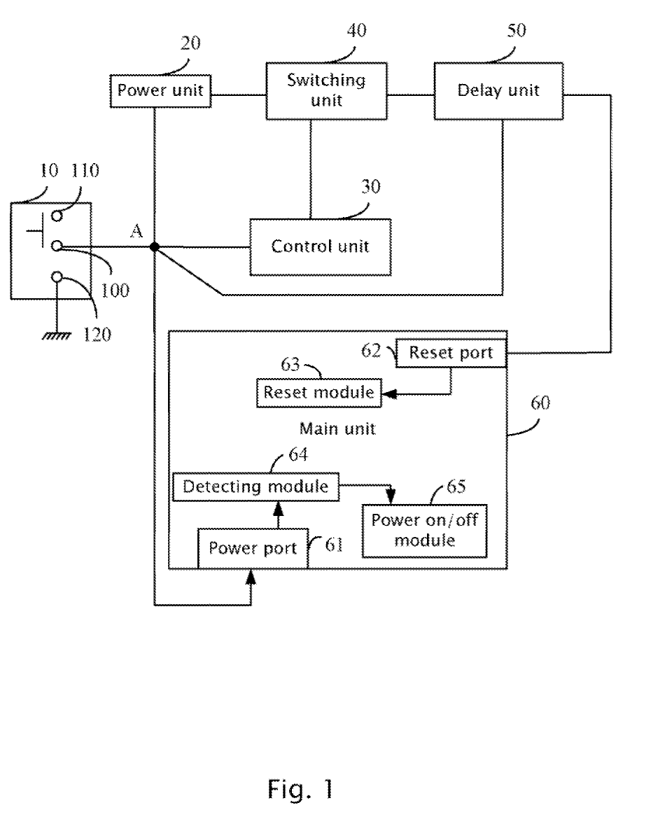

Referring to FIG. 1, an exemplary block diagram of a multi purpose switching circuit in accordance with a preferred embodiment is shown. The multi purpose switching circuit can be incorporated in an electronic apparatus and connected with a main unit 60 of the electronic apparatus. The multi purpose switching circuit includes a multi purpose switch 10. The multi purpose switch 10 is provided for receiving manual operational inputs and consequently producing command signals.

In the preferred embodiment the multi purpose switch 10 is a self-returning switch 10 such as a self-returning slide switch 10 shown in FIG. 1. The self-returning slide switch 10 includes a first contact 10 and a second contact 120. The first contact 110 is suspended and the second contact 120 is grounded. A third contact 100 of the self-returning slide switch 10 is connected to a node A that connects to a power unit 20, a control unit 30, a delay unit 50, and the main unit 60. The third contact 100 defines a first position with the first contact 110 and defines a second position with the second contact 110. A self-returning actuator (not labeled) of the self-returning slide switch 10 rests at the first position when at rest (i.e., no external force (i.e., pushing force) is applied to), and is manually movable between the first position and the second position. In the preferred embodiment, depending on a time length that each time the self-returning actuator is pushed to stay at the second position (hereinafter simplified as “the pushing time)” and a count that the self-returning actuator is pushed to the second position in a predetermined time (hereinafter simplified as “the pushing count”), the self-returning slide switch 10 can receive multiple manual operational inputs and produce multiple command signals.

The main unit 60 implements multiple functions corresponding to the multiple command signals of the self-returning slide switch 10. Specifically, the main unit 60 implements a start up, a shut down, and a reset. The main unit 60 includes a plurality of input ports that includes a power port 61 and a reset port 62. The power port 61 is connected to the node A and is used to obtain power from the power unit 20. The power port 61 is also used to receive power on/off command signals from the self-returning slide switch 10. A detecting module 64 of the main unit 60 detects and identifies the power on/off command signals received at the power port 61 and accordingly signals a power on/off module 65 of the main unit 60 to initiate a start up or a shut down of the main unit 60.

The reset port 62 is connected with the delay unit 50. The delay unit 50 is connected to the power unit 20 via the switching unit 40 that is controllable to switch on or off by the control unit 30. The switching circuit 40 is generally in a switch-on state and conducts power to the delay unit 50, and is switched off by the control unit 30 upon receiving reset command signals from the self-returning slide switch 10. The delay unit 50 discharges over time during the switch off of the switching unit 40 and finally generates reset signals to the reset port 62 of the main unit 60. The reset signals are then transmitted to a reset module 63 of the main unit 60 and initiate the reset module 63 to reset the main unit 60.

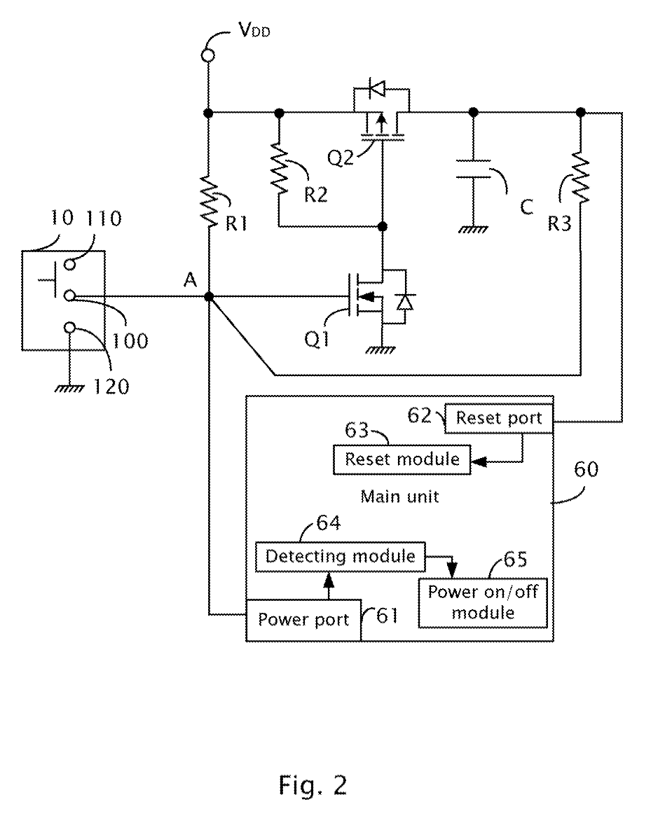

Referring to FIG. 2, a circuit diagram of the multi purpose switching circuit is shown. In this circuit diagram, the power unit 20 is shown as a direct power source VDD. The direct power source VDD is connected to the node A via a resistance component R1. The control unit 30 is shown as an N channel MOS Q1 (hereinafter the “NMOS Q1”) with a gate connected to the node A, a source grounded, and a drain connected to the switching unit 40. The switching unit 40 is shown as a P channel MOS Q2 (hereinafter the “PMOS Q2”) with a gate and a source coupled through a resistance component R2. The gate and the source of the PMOS Q2 are further connected to the direct power source VDD and the NMOS Q1 respectively, and a drain of the PMOS Q2 is connected to the delay unit 50. The delay unit 50 is embodied as an RC (short for “resistance-capacitance”) delay unit 50 that includes a resistance component R3 and a capacitance component C. A first terminal of the resistance component R3 and a first terminal of the capacitance component C are connected between the drain of the PMOS Q2 and the reset port 62, and a second terminal of resistance component R3 is connected with the node A while a second terminal of the capacitance component C is grounded.

At rest, the self-returning actuator of the self-returning slide switch 10 is at the first position, and the NMOS Q1 is in a switch-on state. A voltage drop exists between the gate and the source of the PMOS Q2 and keeps the PMOS Q2 also in a switch-on state. The PMOS Q2 conducts power to the capacitance component C, thus charges the capacitance component C. When the self-returning actuator of the self-returning slide switch 10 is pushed to the second position and pulls the node A to ground, the NMOS Q1 is switched off, and causes the PMOS Q2 to switch off too. The capacitance component C discharges to ground via the resistance component R3 and the node A. The discharge continues during the pushing time of the self-returning actuator and finally generates a low-level reset signal to the reset port 61.

The detecting module 64 detects pushing counts of the self-returning actuator within the predetermined time length and accordingly signals the power on/off module to initiate the starts up or the shut down of the main unit 60. For example, supposing the self-returning actuator generates the power-on command signal when the pushing count is one and generates the power off command signal when the pushing count is two, if the detecting module 64 detects one push on the self-returning actuator in the predetermined time length, the detecting module 64 identifies that a power on command is inputted and sequentially signals the power on/off module 65 to initiate a start up of the main unit 60. If the detecting module 64 detects two push of the self-returning actuator in the predetermined time length, the detecting module 64 identifies that a power off command is inputted and sequentially signals the power on/off module 65 to initiate a shut down of the main unit 60. The predetermined time length is preferably less than a time the capacitance component C discharges to produce the low-level reset signal.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A multi purpose switching circuit connected with a main unit of an electronic apparatus, the main unit being capable of implementing multiple functions, the multi purpose switching circuit comprising:
a multi purpose switch being capable of receiving multiple manual operational inputs and accordingly producing multiple command signals, the multiple manual operational inputs being identified from each other by either a pushing time or a pushing count in a predetermined time length of the multi purpose switch and used to initiate the multiple functions of the main unit.

2. The multi purpose switching circuit as claimed in claim 1, wherein the multi purpose switch is a self-returning switch, the self-returning switch receiving multiple manual operational inputs to produce power on/off command signals and reset command signals, the power on/off command signals being produced depending on the pushing count of the self-returning switch in the predetermined time and the reset command signals being produced depending on the pushing time of the self-returning switch.

3. The multi purpose switching circuit as claimed in claim 2, further comprising a power unit, a control unit, a switching unit and a delay unit, the control unit receives reset command signals from the self-returning switch and controls the switching unit to switch off, the delay unit discharges over the pushing time of the self-returning switch and produces reset signals to the reset module.

4. The multi purpose switching circuit as claimed in claim 3, wherein the delay unit is a resistance-capacitance delay unit.

5. An electronic apparatus, comprising:
a main unit being capable of implementing multiple functions; and
a multi purpose switching circuit comprising a multi purpose switch connected with the main unit and being capable of receiving multiple manual operational inputs and accordingly producing multiple command signals, the multiple manual operational inputs being identified from each other by either a pushing time or a pushing count in a predetermined time length of the multi purpose switch and used to initiate the multiple functions of the main unit.

6. The electronic apparatus as claimed in claim 5, wherein the multi purpose switch is a self-returning switch, the self-returning switch receiving multiple manual operational inputs to produce power on/off command signals and reset command signals, the power on on/off command signals being produced depending on the pushing count of the self-returning switch in the predetermined time and the reset command signals being produced depending on the pushing time of the self-returning switch.

7. The electronic apparatus as claimed in claim 6, wherein the main unit includes a detecting module and a power on/off module, the detecting module detects the pushing count of the self-returning switch in the predetermined time length and identifies the power on/off commands and initiates the power on/off module to implement a start up or a shut down of the main unit.

8. The electronic apparatus as claimed in claim 7, wherein the main unit further includes a reset module used to reset the main unit in accordance with the reset commands.

9. The electronic apparatus as claimed in claim 8, wherein the multi purpose switching circuit further comprises a power unit, a control unit, a switching unit and a delay unit, the control unit receives reset commands from the self-returning switch and controls the switching unit to switch off, the delay unit discharges over the pushing time of the self-returning switch and produces reset signals to the reset module.

10. The electronic apparatus as claimed in claim 9, wherein the delay unit is a resistance-capacitance delay unit.
